(19) United States
(12) Patent Application Publication
(10) Pub. No.: US 2006/0242261 A1
(43) Pub. Date: Oct. 26, 2006

(54) System and method for information technology assessment

(76) Inventors: Jon C. Piot, Dallas, TX (US); John D. Baschab, Dallas, TX (US); John G. Martin, Dallas, TX (US)

Correspondence Address: FISH & RICHARDSON P.C., P.O. BOX 1022, MINNEAPOLIS, MN, 55440-1022, US

(21) Appl. No.: 11/408,484

(22) Filed: Apr. 21, 2006

Related U.S. Application Data
(60) Provisional application No. 60/673,662, filed on Apr. 21, 2005.

(51) Int. Cl. G06F 15/16

(52) U.S. Cl. 709/217

(57) ABSTRACT

According to the present invention system and method, an assessment of IT resources is made utilizing a comprehensive approach to assess the relative strengths and weaknesses of IT departments and/or IT resources. One or more assessment professionals, perhaps utilizing (or replaced by) various software modules, formulate an assessment by combining information derived from series of personnel interviews, systems analysis, and acquisition of relevant internal and external data. This assessment is then manually, dynamically, or automatically generated utilizing one or more algorithms. A master scorecard can be used to track and score each of a number of categories related to IT. The raw scores may be (often automatically) subjected to one or more formulae to produce the final assessment.

### RELATED APPLICATION

This application claims the priority under 35 U.S.C. §119 of Provisional Application Ser. No. 60/673,662 filed Apr. 21, 2005.

### TECHNICAL FIELD

This disclosure relates to assessments and, more particularly, to a system and method for assessment of information technology and related resources.

### BACKGROUND

Information Technology (IT), a term typically used to refer to some or all aspects of managing and processing information in its various forms (data, voice, images, video, multimedia, and other forms, including those not yet conceived), is a critical issue for businesses. Businesses of virtually all sizes have IT resources and, accordingly, issues revolving around the acquisition, implementation, and maintenance. For large companies, there is often an entire department, the IT Department, responsible for IT and its related resources. Smaller operations often include such responsibilities in the duties of an office manager or the like. As IT increases in complexity and variety, businesses find that their needs quickly outstrip current capabilities.

It has been estimated that as much as 50% of capital expenditures by businesses relate to IT functions and infrastructure. For purposes of this disclosure, “infrastructure” is generally used to mean the underlying technological components that constitute the systems architecture for an organization such as hardware, operating systems, networks, databases, development environments, user interfaces, and applications. As business decision makers know all too well, the list of seemingly necessary IT capabilities continues to grow, further increasing IT expenditures within company budgets.

Technology projects abound, while limitless budgets do not. One of the strains an IT department can place on a business is the need to conduct technology projects that will advance the company's product(s) and/or otherwise place the company in a competitive advantage with respect to its competitors. But to conduct such projects, companies allocate funds and/or divert resources from other IT functions. To wisely allocate such resources, the company should not only understand the scope of the technology project, but also understand its relative importance to the business and other objectives it has. Therefore, businesses should normally understand, as well as appreciate, the relevant functions of IT within its organization. In other words, it is often important for a business to understand, even if for only a moment in time, the exact status and nature of its IT needs, IT resources and current utilization so that informed decisions can be made.

### SUMMARY

A method of assessing information technology (IT) may comprise collecting IT information about operations of an enterprise. An IT assessment is then generated based, at least in part, on the collected IT information. In some embodiments, the collection may occur—at least in part—automatically. For example, the automatic collection may include identifying known data associated with the enterprise, dynamically generating at least one of a document request and a questionnaire based, at least in part, on the identified data, and electronically transmitting the dynamically generated request or questionnaire to the appropriate recipient. In some embodiments, the IT assessment may comprise an assessment approach, an executive summary, budget and opportunity analysis, long-term and/or near-term recommendations, and a scorecard.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A-C are diagrams of certain aspects of an example system within the scope of the present disclosure;

FIGS. 2A-B are flowcharts illustrating example methods within the scope of the present disclosure;

FIG. 3 is an example scoring system for various IT features and areas/subareas in accordance with one or more embodiments of the present disclosure;

FIGS. 4A-B are example scorecards with indicia of ratings by area; and

FIGS. 5A-B are example pre-assessment and post-assessment checklists that may supplement the assessment process.

### DETAILED DESCRIPTION

At a high level, the disclosed information technology assessments are based, at least in part, on a comprehensive approach to such assessment of IT (which may also include related or supporting resources). More specifically, an assessment is formulated from combining information derived from one or more series of personnel interviews, systems analysis, and acquisition of outside data relevant to the assessment. For example, to assess the relative strengths and weaknesses of IT departments and/or IT resources, one or more assessment professionals may utilize the system and method of the present invention to make an assessment of an organization's IT and related resources. The assessment professional utilizes IT assessment guidelines, IT assessment templates, detailed scorecards, checklists, document requests, customer preparation documents, best practices lists interview guides, engagement letters and post-mortem documents to facilitate the overall IT assessment. Such information and data gathered by one or more assessment professionals can be plugged into one or more algorithms to determine results and to suggest recommendations and follow up action items and information to improve an entity's use of IT and related resources. The IT assessment produces assessments that have a standard look and feel, based upon the six key components, but are also highly customized to meet the specific circumstances, needs and desired end-of-assessment results. In other words, IT assessments similar to that described may help gauge the effectiveness of the IT group (or department or third party), identify improvement areas, and benchmark against industry standards. Based on such analysis, potential courses of action may be determined or developed for achieving desired results because—in many cases—a thorough assessment helps enable a broader spectrum of alternatives to enhance IT performance. For example, these assessments may help the enterprise's current staff, applications, and budget to be maximized. In another example, these assessments may help provide a roadmap to cost savings of 10-25% of current IT budget, coupled with improved capacity for business improvement IT projects.

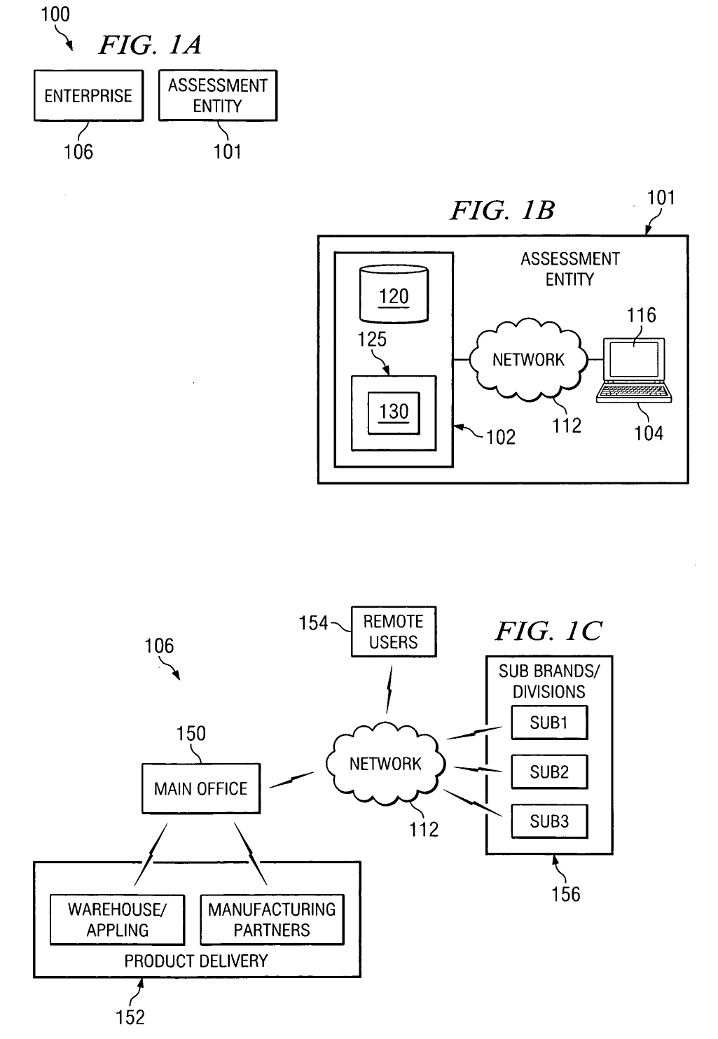

With respect to FIG. 1A, system 100 is any system, environment, partnership, or contractual arrangement (or portion thereof) that allows an assessment entity 101 to efficiently collect vast—yet targeted—amounts of IT and related data to provide a comprehensive assessment of the IT and related resources of an enterprise 106 of any size. This information and data, perhaps gathered by the assessment professional(s), is plugged into one or more algorithms to determine results of same and to suggest recommendations and follow-up action items and information to improve an entity's use of IT and related resources. Assessments produced according to such techniques may comprise six primary components and have a similar look and feel. But, of course, assessments can be highly customized based upon the specific circumstances, needs, and desired end-of-assessment results for that organization.

The assessing entity 101 may be any consulting, hired, or other organization that uses, perhaps by one or more assessment professionals, IT assessment guidelines, IT assessment templates, detailed scorecards, checklists, document requests, customer preparation documents, best practices lists interview guides, engagement letters and post-mortem documents to facilitate the overall IT assessment. A best practices document may be utilized by certain assessment professional that contains frequently asked questions, advice, and approaches for conducting an effective assessment. The general focus is on data collection, interviewing, budget analytics, and opportunity analysis. Interview guides may also be used and are often sorted by interviewee type (CEO, COO, CFO, CIO/IT director, operations specialist, infrastructure, applications management, business unit manager). FIG. 1B shows an example configuration of the components that may be utilized to help collect this IT data and develop the appropriate assessment. As illustrated, assessing entity 101 is a distributed client/server system supporting a business 106 or other entity that may (however indirectly) benefit from an IT assessment. For example, the assessing entity 101 may include a server 102 that is connected, through a network 112, to one or more local or remote clients 104. But assessing entity 101 may be a standalone computing environment or any other suitable environment without departing from the scope of this disclosure.

Enterprise 106 may comprise a “business,” “company,” “customer,” or “organization” and each of these terms may be used interchangeably to describe entities (whether business, government, or non-profit) for which the present system and method can be used. Moreover, the IT information may be collected from or via any suitable intermediary as appropriate. For example, if the IT tasks are outsourced by enterprise 106, then the IT data may be collected from internal contractor managers, from the contractors, from third party auditors, and so forth. In another example, the information may be automatically collected from system administration software that helps manage software, hardware, networks, and so forth. FIG. 1C illustrates an example architecture of an enterprise 106 (or it's IT department, etc.). As illustrated, this example architecture includes a main office 150, one or more remote users 154, one or more departments (represented by the “product delivery”) 152, and one or more divisions, sub-brands, or tightly integrated partners 156. The terms will also be used to apply to entities of all sizes and organizational structures. From single member companies to multi-national concerns, the present invention system and method of IT assessment can be utilized to provide specific and accurate assessments of IT and related resources.

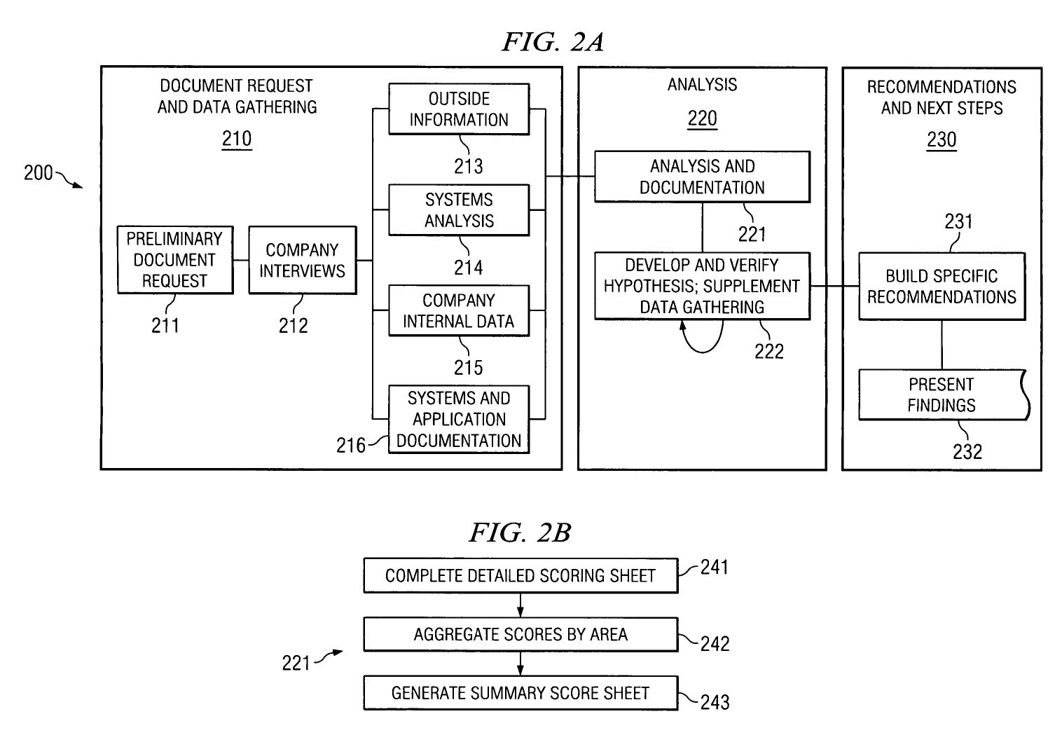

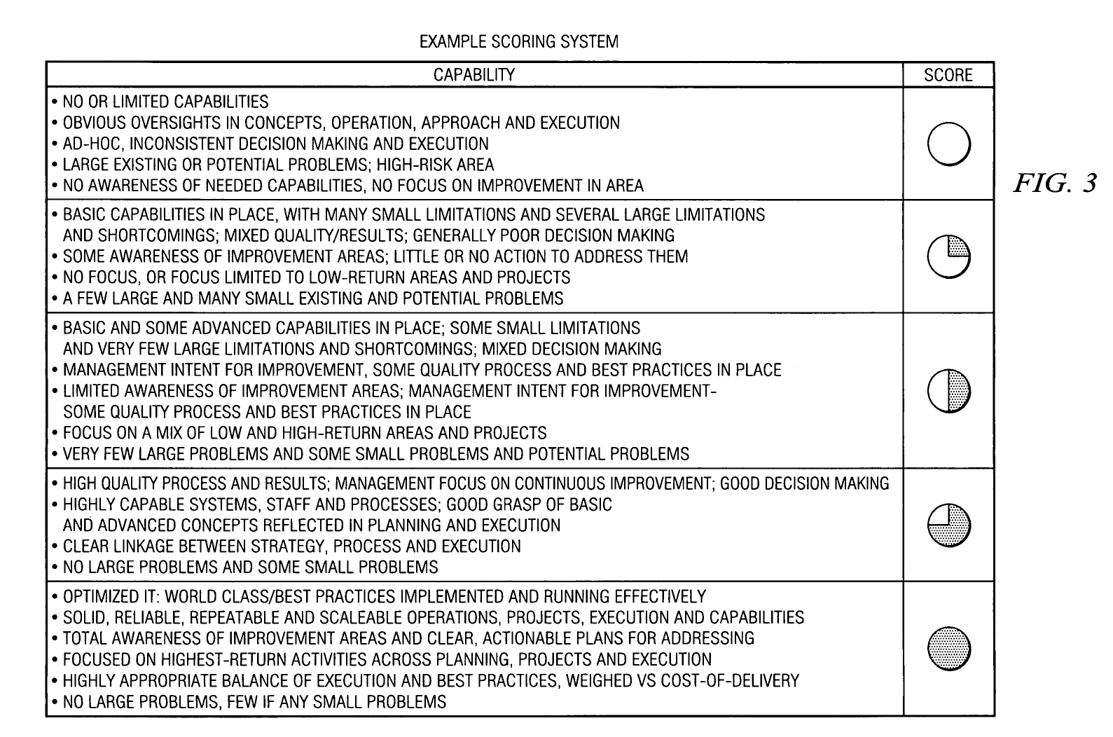

For example, as shown in FIG. 2A with example method 200, to assess the relative strengths and weaknesses of IT departments and/or IT resources, one or more assessment professionals make an assessment of an organization's IT and related resources. Generally, this process includes the collection of information at step 210, the assessment of such collected information at step 220, and the providing of recommendations at step 230. More specifically, an assessment can formulated from combining information derived from system documents (216), internal company data (215), systems analysis (214), and acquisition of outside data (213) relevant to the assessment. Document requests (211) and customer interviews (212) may be conducted according to customizable templates. The information derived from such document requests coupled with internal and outside data relevant to the assessment, actual systems analysis, and data gathered by the assessment professional(s) is plugged into one or more algorithms (221) to determine or calculate results and to suggest recommendations and follow up action items and information to improve an entity's use of IT and related resources. Next, the assessment entity 101 develops a hypothesis regarding the assessment and validates the hypothesis (222). The results are used to formulate recommendations and findings (231) and provided to the appropriate party (232), which may be the enterprise 106 or an affiliate, parent, successor, third party, or other entity associated with it. The IT assessment template includes the framework for conducting assessments and capturing results, often using scorecards. These scorecards provide the background data to support the IT department scoring in the ten major categories. The scorecards may comprise rating a number of subject matter categories (e.g., IT leadership, Budget, and Staffing) via broken out sub-categories (e.g., IT steering, Budget Management, and Morale). The scoring system, such as that shown in example FIG. 3, is used to formulate an overall score for the assessment, broken down into the major categories and sub-categories so that both big-picture and specific analysis can be conducted and reported in the assessment. Detailed scorecards by major area and sub-area contain detailed data gathering templates, as well as specific questions to be asked. In certain cases, the collected data may be subjected to analysis according to Maslow's hierarchy of needs to further refine or supplement the assessment.

Returning to FIG. 1B, server 102 comprises any computer and may be communicably connected with any number of clients and/or other network devices such as switches or routers, printers, docking stations, or others. For example, the server 102 may be a blade server, a mainframe, a general-purpose personal computer (PC), a Macintosh, a workstation, a Unix-based computer, a web or email server, or any other suitable device. Indeed, server 102 can be implemented using computers other than servers, as well as a server pool. The present disclosure contemplates computers other than general purpose computers as well as computers without conventional operating systems. As used in this document, the term “computer” is intended to encompass a personal computer, workstation, network computer, or any other suitable processing device. Server 102 (as well as other computers) may each be adapted to execute any operating system including Linux, UNIX, Windows, Windows Server, z/OS, or any other suitable operating system so long as the computer remains operable to process or display native or massaged assessment data. The server 102 typically includes an interface for communicating with the other computer systems, such as the client 104, over the network in a client-server or other distributed environment. Generally, the interface comprises logic encoded in software and/or hardware in a suitable combination and operable to communicate with network. More specifically, the interface may comprise software supporting one or more communications protocols associated with the communications network or hardware operable to communicate physical signals. In short, server 102 may comprise any computer with software and/or hardware in any combination suitable to receive or retrieve assessment information, generate web pages or other output based on the assessment data, and communicate the output to users or one or more clients 104 via a network 112.

Network 112 facilitates wireless or wireline communication between server 102 and any other computer. The network may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. Indeed, while illustrated in FIG. 1B as internal to assessment entity 101 (such as a subnet, intranet, virtual LAN, or other local network), it may also encompass other networks (not shown). For example, there may be a first network portion 112a that is associated with assessment entity 101, a second network portion 112b that is associated with enterprise 106, and a third party network (such as the Internet) that helps coupled the two portions. In another example, the first portion 112a and the second portion 112b may comprise subnets of one network for a business or other organization.

Returning to the server 102, it typically includes (or is coupled with) at least memory 120 and a processor 125. Memory 120 may include any memory or database module and may take the form of volatile or non-volatile memory including, without limitation, magnetic media, optical media, random access memory (RAM), read-only memory (ROM), removable media, or any other suitable local or remote memory component. Memory 120 typically includes collected IT data (such as documents, questionnaires, surveys, licenses, audits, etc.), assessment templates, and previously generated or in-progress assessments in a centralized or distributed database, but may also include any other suitable data including security logs, web logs, HTML pages and templates, look and feel elements, word documents, emails, and others. Generally, the centralized database may comprise a relational database described in terms of SQL statements or scripts. Relational databases often use sets of schemas to describe the tables, columns, and relationships in the tables using basic principles known in the field of database design. In another embodiment, the centralized database may comprise XML documents, flat files, Btrieve files, or comma-separated-value (CSV) files. In short, the centralized database may comprise one table or file or a plurality of tables or files stored on one computer or across a plurality of computers in any appropriate format. Moreover, the centralized database may be local or remote without departing from the scope of this disclosure and store any type of appropriate IT and other data.

The collected data may be temporarily or (relatively) permanently stored in memory 120 and may comprise checklists, forms, templates, outside information, system analysis, internal data, system and applications data, and any other IT and related information. The checklist may be a workflow checklist of all assessment activities including closing and may be completed for each assessment. Document requests forms may be handed off to clients in preparation for IT due-diligence efforts, along with an explanation of what scorecard sections the documents are relevant for in the event of client questions. For example, the document requests may include requests for some or all of organization charts, IT budget and capital expenditure documents, inventory of current applications and infrastructure projects, technical architecture diagram, application architecture diagram, vendor contracts, and standard operating procedures, production run guides, or run books. Organization charts may contain organizational structure diagrams, including names, titles, and number of staff by function. This may include both corporate and IT department organizational structures within or utilized by enterprise 106. The IT budget and capital expenditure (CAPEX) documents contain a detailed budget with planned and actual IT spending figures for the past three (3) years for the entire company and broken out by location/region in the areas of hardware, software, labor (internal personnel fully burdened), data and communications, and other. Such documents may also include historical CAPEX spending for each of the past three years (for example), categorized by mainframe, PC, peripherals, mid-range, servers, network, telecom, and such. The inventory of current applications and infrastructure projects may be a near-complete list of IT projects currently underway, planned, completed, as well as cancelled. Each project may include associated information such as ID number or unique identifier, name, description, start date, end data, project cost, status, priority, business unit sponsor, and IT assigned resource. The technical architecture diagram normally includes documentation illustrating and describing the network including topology, diagrams, server footprints, and so forth. The application architecture diagram contains all documentation illustrating and describing the application architecture including context diagrams, interface specifications, and such. The vendor contracts document includes or otherwise references vendor contracts, licenses, and other agreements in place for technology including but not limited to hardware maintenance, software maintenance, telecommunications, development, consulting, and other professional IT or IT-related services. Such contracts may be electronic, paper, or combination thereof. The standard operating procedures (SOP) are represented by production run guides or run books containing full documentation of appropriate SOPs. These may include new user, e-mail outage, server maintenance, backup, etc. Of course, the preceding requested documents are for example purposes only and many other documents may be requested to help provide further insight into the IT function. Such example documents may include Hardware Inventory, Software Inventory, Development Methodologies, user guides, application software, system training documents, and so forth. A client prep document often accompanies the document request form to explain the rationale, approach, timing, and expectations of the IT assessment process.

The collected data may also include answers to questionnaires. For instance, a questionnaire may include some or all of the following categories of questions: IT governance and leadership, budget, organization and staff, IT demand management, project management, application management, operations, infrastructure/technical architecture, standards, vendor management, and miscellaneous. Example questions may include:

What is the reporting relationship between IT and the business unit (e.g. CFO, COO)?

What are the overall senior management level goals for IT?

What is the relative importance of the following goals for senior management?
a. Reduce IT costs
b. Improve IT service level (helpdesk, vendor services)
c. Improve IT reliability (disaster recovery, application uptime, network uptime, project completion)
d. Improve business user satisfaction with IT
e. Use IT for creating new products/services

Do you use any metrics to track the success of your daily IT operations and project?

Provide any and all collected measurements of IT performance including system performance, user satisfaction surveys and any other relevant material.

Provide company income statements broken out by location/region or service line for the entire company for this year to date and for the previous three years.

Are any IT costs embedded in other budgets? If so, what percent?

Provide an overview of capital expenditure budgeting process and your operating budgeting process. This overview may include historical capital expenditure spending for each for each of the past three years, by category.

Provide an organizational structure diagram, including names, titles and number of staff by function

Provide an inventory, including the following details, of all IT projects currently underway. Project details may include:
a. Dates (started, planned finish, changes)
b. Business cases
c. Project description
d. Detailed effort expenditure
e. Projected ROI, payback or other financial measure
f. Business unit owner
g. IT owner
h. Priority
i. Work plan

What is the IT department's process for managing applications (patches, upgrades, hot-fix, break-fix, enhancement requests, capacity management)?

Provide an application overview, including information pertaining to the corporate application footprint, interfaces, and any other high-level application overview information.

For package applications, what is the estimated level of customization overall? What is the breakdown of customization by module (e.g. A/R, GL, Forecasting, etc.)

Describe the department software development (or package configuration) quality assurance process.

What is the IT department plan in the case of a disaster that physically affects the IT department?

Are there any asynchronous or background batch jobs?

Technical architecture documentation such as:
a. Network topology
b. Server footprints
c. Server room blueprints
d. Technical configuration for servers, applications, DB's

Describe and provide any relevant documents regarding the IT department's development standards.
a. Variable, library and other code naming conventions
b. Process checkpoints
c. Development environment
d. Development tools used
e. Quality assurance tools used

What is the IT department's process for selecting vendors?

Of course, the preceding questions are for example purposes only and none, some, or all of these questions may be used. Moreover, derivatives of these as well as many other questions may be presented to the enterprise 106 to obtain or otherwise collect IT data.

Turning to the assessments that may be stored (at least temporarily) in memory 120, each assessment may be broken down into six components: assessment approach; executive summary (including a list of next steps); budget and opportunity analysis; long-term recommendations; near-term recommendations; and scorecard. The assessment approach component is used to highlight the methodology and sources of data used in an IT assessment. Essentially, this component is used to explain the scope of effort and review that that formed the assessment. It preferably includes a summary of hours consumed, resources and types used, number and type of interviews conducted, documents/page counts reviewed, outside sources consulted and locations visited (if applicable). It will also include an overview (including flowcharts) of the methodology used for a particular assessment. A timeline of the work plan and key events associated with the assessment will also be included. Finally, an interview summary (broken down by category and individual) will be included. Importantly, the information imparted, as well as the format of such information, is dictated by the structure of the organization and other parameters of the organization for which the assessment is being conducted. For example, the nomenclature commonly used within the organization will be employed, where possible, to provide the greatest ease of use for the organization.

The executive summary component can be further broken down into six key content areas: IT department scorecard summary; other key findings; long-term/strategic recommendations; specific near-term recommendations; risk areas and potential mitigations; and conclusions and next steps. The executive summary is the document focus, and will contain a summary IT scorecard and specific recommendations. The IT department scorecard summary and short-version by area may use standard grid and Harvey balls and exclude any out-of-scope areas. For consistency, grid definition and Harvey ball definitions are normally the same for each assessment. For each area, a rolled up score and one to five explanatory bullets should be included. The Executive Summary may also include other key findings that are not in or represented by the scorecard or otherwise requiring focus.

Long-term/strategic recommendations, which are the same as near-term and should be focused on long-term support of corporate direction and strategy and demonstrate clear link to business plans for each recommendation. Specific near-term recommendations are often free text diagrams or other supporting information kept at summary level. They may be clear, specific and actionable and not exceed two pages. Risk areas and potential mitigations may be a single page chart that includes any specific risk areas that should be addressed by the client. This is particularly important for private equity/due diligence efforts and should address likelihood of risk and specific steps to mitigate. Conclusions and next steps are typically one to four bullets summarizing key points from assessment, next steps to be completed (e.g., interviews, data to be gathered, budget changes, etc.) and outsourcing tie-in or additional management consulting to be proposed.

The budget and opportunity analysis section focuses on budget benchmarking, potential cost reductions and opportunities to better leverage technology. Budget breakout by area includes people, hardware, software, services, telecom, CAPEX, and others. Operational and CAPEX budget trends and explanation are often included. Benchmarking vs. industry spending may be presented through rationale for industry choice, adjustments for scale economics, operational/business complexity/user count/company locations, CAPEX, and operating benchmark overage/underage. Potential cost reduction opportunities consist of source of savings, opportunity size, business/IT performance, budget and accelerated depreciation implications, risk, effort and time to achieve. Opportunity assessment may also be calculated using metrics captured from capital investments, projects, revenue-driving technologies, labor/capital or capital/labor substitutions (within IT or organization overall), risk, effort and time to achieve, source of the information (internal or external), and explanation of swap analysis.

The long-term recommendations section focuses on strategic steps that can be implemented over one to five years based upon the results of the assessment. Such steps are typically centered around re-aligning the IT department and systems over a period of years. These recommendations are specific and are preferably closely linked to the business strategy of the organization for which the assessment is being conducted. In general, the recommendations are focused on large-scale business drivers, such as revenue improvement, costs reduction and business control. One example recommendation may be investing in new, scalable financial systems to support planned business growth, acquisitions and scaling, which improves management control of business units via improved data and reporting. Another example recommendation may include the changing of development standards from C++ to NET may lower some system's complexity and implicit labor costs, improve the IT staff cost baseline, allow access to a larger labor pool, and enhance system flexibility. Further examples include investment in in-store systems that may provide real-time feedback to management will provide greater control and faster decision-making. Investigating off-shore development and/or QA will reduce overall systems labor costs. Additionally, the recommendation preferably include a timeline associated with it and typically one of the long-term recommendations will include a surge project that encapsulates most, if not all, of the short-term recommendations that are outlined in the Near-Term Recommendations component.

The near-term recommendations component contains details of the short run steps that are recommended as a result of the assessment. Such steps are preferably specific, and action-oriented. Additionally, they include details of the action to be taken, the expected results, the associated costs, a level of effort likely required, the risk/business impact, the resources likely required, and the expected or desired timing. In general, the focus of these recommendations is on limited-scope, “burning platform,” high-impact issues.

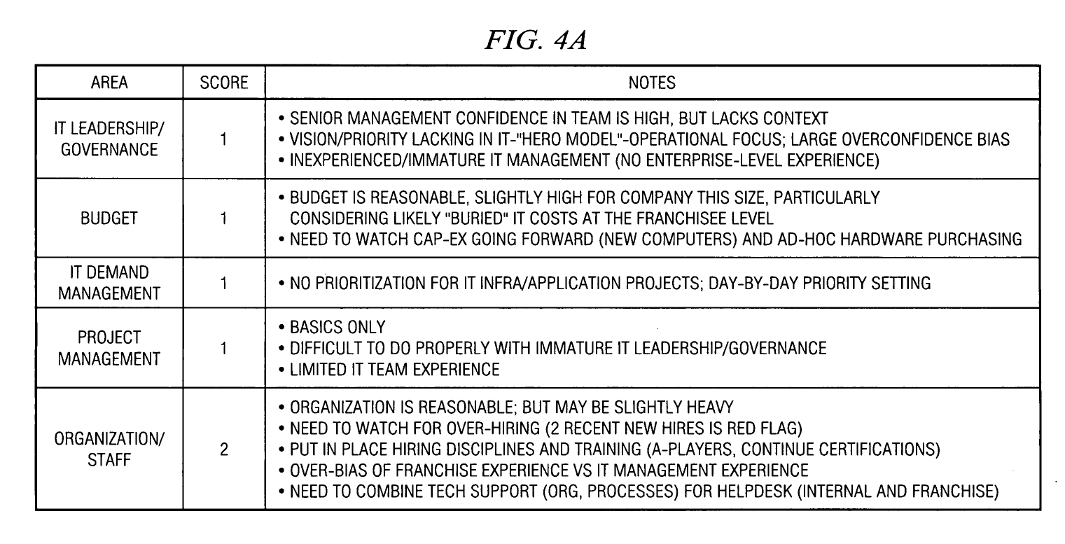

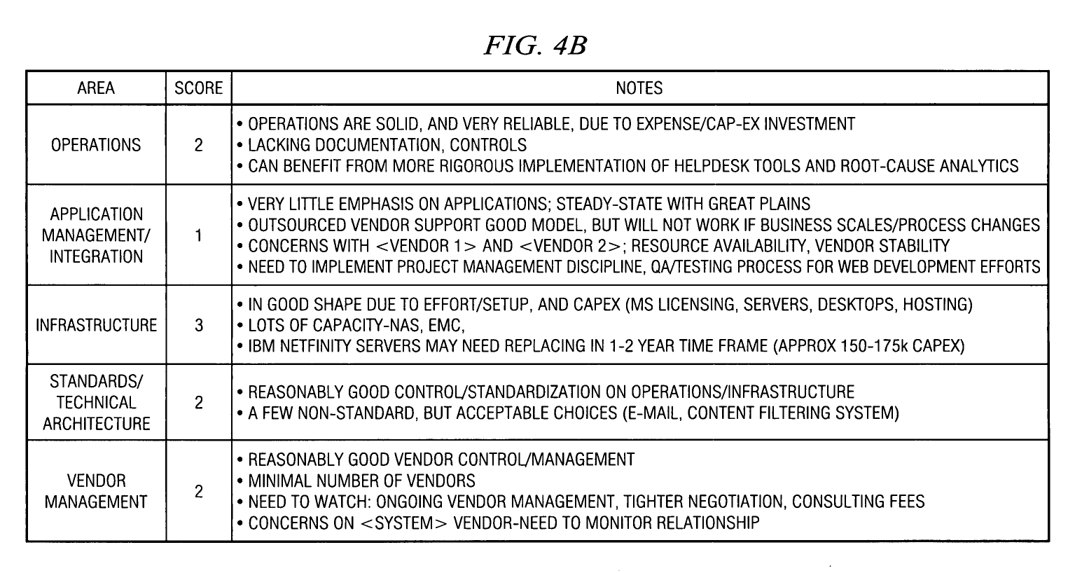

The final section contains the scorecard details, with one to three supporting pages for each area. The section should be organized around the ten major scorecard areas as shown in example FIGS. 4A-B. The first page includes scoring by sub-area with rationale, notes, and other relevant data. The remainder of the section typically contains any supporting details or storyline including text, charts, tables, and such. If appropriate, this section may be skipped, or made appendix material for short-cycle due diligence efforts. Creation of this section will be facilitated by the detailed scoring spreadsheets as show in FIG. 2B. As mentioned above, the techniques may include operations that are performed generally by assessment engine 130 or some other library or process. In certain cases, the operations may be automatically performed under the control, supervision, and/or monitoring of the server 102. These techniques may also be performed, at least partially, by assessment professionals. Regardless of the particular implementation, detailed scoring sheets are completed or computed at step 241 in example method 221. Next, at step 242, these scores are aggregated. In many cases, this aggregation process may include filtering, disregarding the lowest score and the highest score, determination of statistic variances, normalization, and other automatic or manual process. These aggregated scores are then used to generate a summary scoresheet.

The dynamically generated assessment may also contain an appendix that outlines and includes supporting data and information for the assessment. Typical contents can include:
i. Staff resumes, appraisals
ii. Staff assessment spreadsheet
iii. Analyst information on vendors
iv. Vendor contracts
v. IT systems documentation
vi. Fixed asset inventories
vii. Project plans
viii. Project business cases, charters
ix. IT Standard Operating Procedure Documentation
x. Equipment/capacity reviews
xi. Other relevant IT documentation (process, DR plans, system requirements, other)
   In some cases, the appendix materials will be based on the document request and may not include working papers and interview notes.

The processor 125 executes instructions and manipulates data to perform the operations of server and may be, for example, a central processing unit (CPU), an application specific integrated circuit (ASIC), or a field-programmable gate array (FPGA). Although described in terms of a single processor 125 in the server, multiple processors may be used according to particular needs, and reference to processor is meant to include multiple processors where applicable. In certain embodiments, processor executes one or more processes associated with an assessment engine 130.

Assessment engine 130 could include any hardware, software, firmware, or combination thereof operable to collect, receive, output, or otherwise process any number of IT data and related materials. For example, the assessment engine 130 may receive IT or other assessment information from remote or local sources, process it according to various algorithms, and store the processed data in a centralized database. The processing may include: i) automatic generation of customized requests and surveys based on templates (including adding, removing, and modifying specific requests or questions and adding of the client's logo); ii) dissemination of such requests and surveys; iii) collection, aggregation, and scoring of such data; iv) creation of the IT Assessment; and such. The assessment engine 130 may be written or described in any appropriate computer language including C, C++, Java, Visual Basic, assembler, Perl, any suitable version of 4GL, and others or any combination thereof. It will be understood that while the assessment engine 130 is described as a single multi-tasked module, the features and functionality performed by this engine may be performed by multiple (perhaps standalone) modules such as, for example, a collection module, a scoring module, and others. Further, while described as internal to the server, one or more processes associated with assessment engine 130 may be stored, referenced, or executed remotely. Moreover, assessment engine 130 may be a child or sub-module of another software module without departing from the scope of this disclosure. In one embodiment, the assessment engine 130 may be referenced by or communicably coupled with applications or browsers executing on one or more client computers.

The assessment engine 130 may be operable to perform or aid a user in performing the collection and assessment. For example, assessment engine 130 may automatically tailor and transmit emails with document requests, surveys, or other collection components (which may be attached, embedded, or otherwise referenced by the email). In this situation, the assessment engine 130 may automatically identify certain already known or otherwise publicly available data about enterprise 106 such as, for example, the company's name, the logo, a business type, the IT architecture or structure (i.e., outsourced IT activities or org chart). In another example, the assessment engine 130 may automatically collect the IT information from enterprise administration software that helps manage software, hardware, networks, and so forth. This automatic collection may include any data mapping, conversion, normalization, or other data processing as appropriate. In yet another example, the assessment engine 130 may present an interface (via the GUI described below) that allows the user to score each assessment area and subarea. In this example, the user may rate the IT department according to the question from a “1” to “5” by putting a “1” in the column corresponding with the 1-5 rating. This 1-5 score should be based on the scoring guidelines found in the IT Assessment Guidelines and the highest rating normally takes precedence (e.g. if an item is rated both a 1 and a 3, the 3 rating will be counted). Typically, line items ending with “. . . ” are not considered questions and should not be scored (the sub-items that follow should be scored). If a question is not relevant to the particular client (enterprise 106), then it is normally not counted in the score and noted with a non-blank character in the “N/A” column. The interface may include a “Comp?” column that shows questions that are completed (green with check mark) and have not (highlighted). Scoring is then typically summarized with a Harvey ball at the subcategory level according to the following ratings: 0-1 =0, >1-2 =1, >2-3 =2, >3-4 =2, >4. The overall score for the category is typically based on an equal weighting of all questions (instead of a sub-category-equal weighting) and the summary scoring worksheet is dynamically linked to the IT Assessment Scorecard detail sheet and will automatically update as additional collection occurs or the collected data revised.

Each client 104 is any computing device operable to present the user with raw or processed IT and related information via a graphical user interface (GUI). At a high level, each client 104 includes at least the GUI and comprises an electronic computing device operable to receive, transmit, process and store any appropriate data associated with system 100. It will be understood that there may be any number of clients 104 communicably coupled to server 102. Further, “client” and “user” may be used interchangeably as appropriate without departing from the scope of this disclosure. As used in this document, client 104 is intended to encompass a personal computer, workstation, network computer, kiosk, wireless data port, personal data assistant (PDA), server, one or more processors within these or other devices, or any other suitable processing device. For example, the client may comprise a computer that includes an input device, such as a keypad, touch screen, mouse, or other device that can accept information, and an output device that conveys information associated with the operation of server or clients, including digital data or visual information, via the GUI. Both the input device and output device may include fixed or removable storage media such as a magnetic computer disk, CD-ROM, or other suitable media to both receive input from and provide output to users of clients through the GUI 116.

GUI 116 comprises a graphical user interface operable to allow the user of client to interface with system to view information associated with the IT data and the assessment thereof. Generally, the GUI 116 provides the user of client with an efficient and user-friendly presentation of data provided by system. The GUI 116 may comprise a plurality of frames or views having interactive fields, pull-down lists, and buttons operated by the user. It should be understood that the term graphical user interface may be used in the singular or in the plural to describe one or more graphical user interfaces and each of the displays of a particular graphical user interface. Further, the GUI 116 contemplates any graphical user interface, such as a generic web browser, that processes information in system and efficiently presents the information to the user. Server 102 can accept data from client 104 via the web browser (e.g., Microsoft Internet Explorer or Netscape Navigator) and return the appropriate HTML, XML, or other responses using network.

The preceding techniques and accompanying descriptions illustrate example methods. But this disclosure contemplates using any suitable technique for performing these and other tasks. Accordingly, many of the steps may take place simultaneously and/or in different orders than as shown. Moreover, any suitable system may use methods with additional steps, fewer steps, and/or different steps, so long as the techniques remain appropriate. For example, it will be understood that the software may execute portions of the described processes in parallel or in sequence.

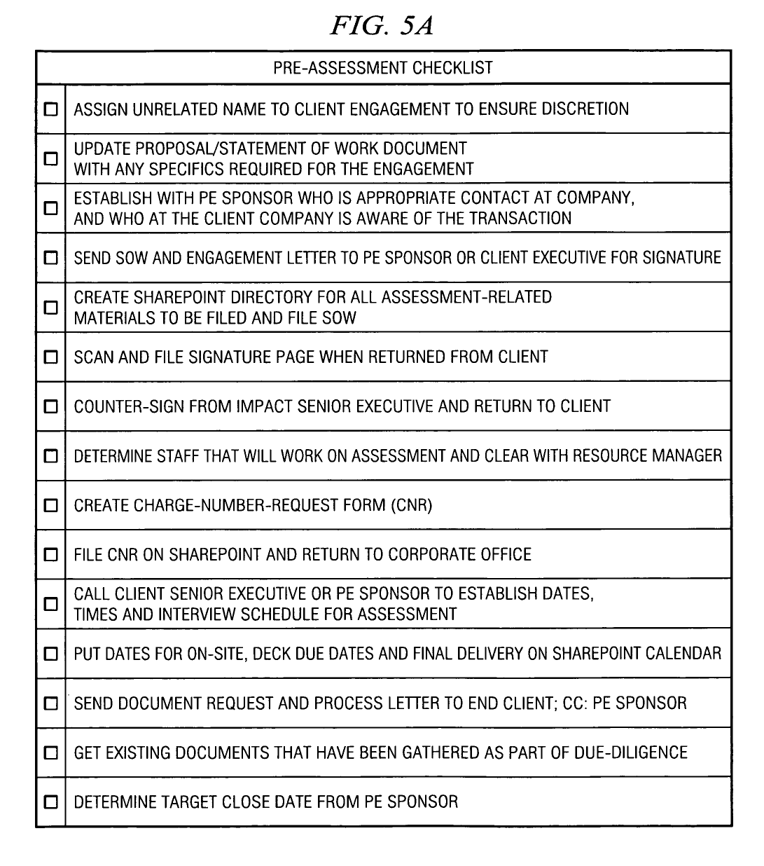

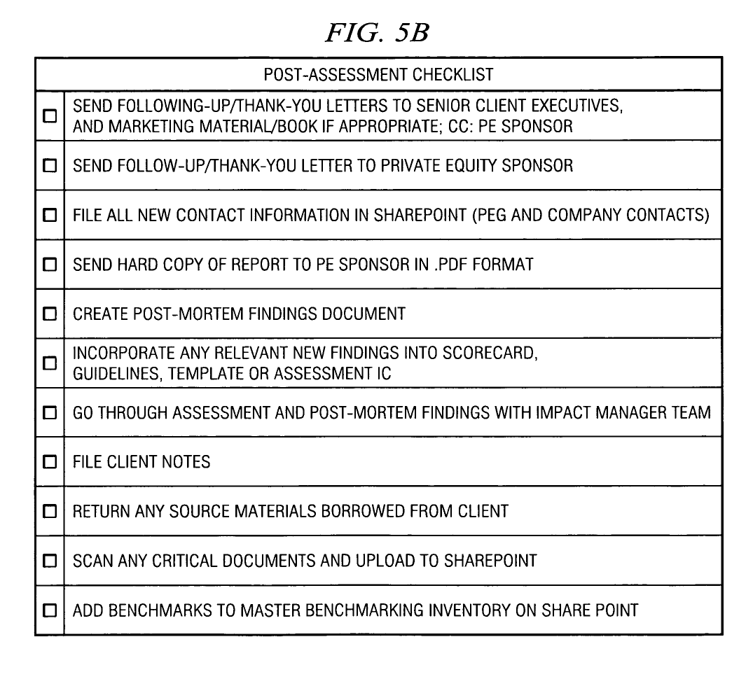

In other words, a number of embodiments have been described and it will be understood that various modifications may be made without departing from the spirit and scope of the disclosure. For example, while described herein as being implemented in a scorecard matrix, the components and techniques may be used in any similar application, module, or web service operable to provide user friendly, yet comprehensive assessments. Moreover, it is not required that the assessing entity 101 and enterprise 106 reside within the same environment, system, or network, as described. Indeed, the particular assessing entity 101 and the particular enterprise 106 may reside in different parts of the globe and may electronically exchange data using various channels as appropriate. Also, the assessment entity 101 may use pre- and post-assessment checklists (such as those illustrated in FIGS. 5A-B) to complement the assessment process, thereby potentially providing a more customized approach to each assessment based upon the general templates and to help verify the accuracy of the assessment. Accordingly, other embodiments are within the scope of the following claims.

What is claimed is:

1. A method of assessing information technology (IT) comprising:
collecting IT information about operations of an enterprise; and
generating an IT assessment based, at least in part, on the collected IT information.

2. The method of claim 1, wherein collecting IT information about operations of the enterprise at least partially comprises automatic collection of the IT information.

3. The method of claim 2, the automatic collection comprising:
identifying certain data associated with the enterprise;
dynamically generating at least one of a document request and a questionnaire based, at least in part, on the identified data; and
electronically transmitting the dynamically generated request or questionnaire to the appropriate recipient.

4. The method of claim 3, the certain data comprising a company name, a logo, and an IT organizational structure.

5. The method of claim 2, the automatic collection comprising receiving at least a portion of the IT information from enterprise management software associated with the enterprise.

6. The method of claim 1, at least part of the IT information comprising data involving third party operations associated with the enterprise.

7. The method of claim 1, the enterprise comprising a governmental entity.

8. The method of claim 1, the IT assessment comprises an assessment approach, an executive summary, budget and opportunity analysis, long-term recommendations, near-term recommendations, and a scorecard.

9. The method of claim 1, wherein the scorecard comprises a summary portion and a detailed portion and is generated by:
scoring each of a plurality details about the operations based on the collected IT information, each of the details associated with one a plurality of categories; and
aggregating the scores of the various details for each category.

10. The method of claim 1 further comprising:
utilizing a pre-assessment checklist prior to the collection of the IT information; and
utilizing a post-assessment checklist to verify the generation of the IT assessment.

11. Software for assessing information technology (IT) operable to:
automatically collect IT information about operations of an enterprise;
bundle the automatically collected data with manually collected IT information that is received from a client; and
generate an IT assessment based, at least in part, on the collected IT information.

12. The software of claim 11, the automatic collection comprising:
identifying certain data associated with the enterprise;
dynamically generating at least one of a document request and a questionnaire based, at least in part, on the identified data; and
electronically transmitting the dynamically generated request or questionnaire to the appropriate recipient.

13. The software of claim 12, the certain data comprising a company name, a logo, and an IT organizational structure.

14. The software of claim 11, the automatic collection comprising receiving at least a portion of the IT information from enterprise management software associated with the enterprise.

15. The software of claim 11, at least part of the IT information comprising data involving third party operations associated with the enterprise.

16. The software of claim 11, the enterprise comprising a governmental entity.

17. The software of claim 11, the IT assessment comprises an assessment approach, an executive summary, budget and opportunity analysis, long-term recommendations, near-term recommendations, and a scorecard.

18. The software of claim 11, wherein the scorecard comprises a summary portion and a detailed portion and is generated by:
scoring each of a plurality details about the operations based on the collected IT information, each of the details associated with one a plurality of categories; and
aggregating the scores of the various details for each category.

19. The software of claim 11 further operable to:
receive inputs based on a utilized pre-assessment checklist prior to the collection of the IT information; and
receive inputs based on a utilized post-assessment checklist to verify the generation of the IT assessment.

20. An Information Technology (IT) assessment for an enterprise comprising:
an assessment approach;
an executive summary;
a budget and opportunity analysis;
a plurality of recommendations; and
a scorecard, wherein the assessment is at least partially generated based on collected IT information about operations of an enterprise.
